(19) United States
(12) Patent Application Publication
(10) Pub. No.: US 2003/0072273 A1
(43) Pub. Date: Apr. 17, 2003

(54) System and method for transmitting data in Ultra Wide Band frequencies in a de-centralized system

(76) Inventors: G. Roberto Aiello, Palo Alto, CA (US); James L. Taylor, Epone (FR); Minnie Ho, Los Altos, CA (US)

Correspondence Address: SIERRA PATENT GROUP, LTD., P O BOX 6149, STATELINE, NV, 89449, US

(21) Appl. No.: 10/238,995

(22) Filed: Sep. 9, 2002

Related U.S. Application Data
(60) Provisional application No. 60/318,103, filed on Sep. 7, 2001.

(51) Int. Cl. H04B 7/00

(52) U.S. Cl. 370/310.2; 370/328

(57) ABSTRACT

A decentralized network that transmit data between devices using UWB signals. A device needing a data transmission participates in a contention phase after the system is idle for a predetermined amount of time. The device then generates a packet that includes a control header having synchronization data and transmits the packet to a receiving device.

### CROSS-RELATED

This application is a utility application claiming priority to an earlier filed U.S. Provisional Application No. 60/318,103 filed Sep. 7, 2001

### BACKGROUND OF THE INVENTION

1. Field of the Invention

The present invention relates to a system for transmitting data using Ultra Wide Band (UWB) radio frequencies. More particularly, this invention relates to a system using UWB to transmit data in a de-centralized system and where the data is time sensitive. Still more particularly, this invention relates to transmitting data using UWB in a home entertainment system.

2. Problem

Many consumer electronic devices require the sharing of large amounts of digital data with other devices. One particular type of system in which devices must share a large amount of data is a home entertainment system. In a home entertainment system, devices such a Digital Video Disc (DVD) player, television, and stereo must transmit data between one another to provide video and audio presentations.

Currently, the most common way of connecting these devices to transmit data is by using wired connections. The use of wires to connect devices in a system requires that a user actually lays the wire and physically connects the device to the system. This requires exurbanite amounts of time for the user to lay the wire and connect the wire to the devices. Furthermore, once a device is connected to the system, it is difficult to move the device as the physical connection of the device must also be moved.

For these reasons, wireless systems are desired for use in systems, such as home entertainment systems. In a wireless system, Radio Frequency (RF) signals are used to transmit signals between devices. However, there are many problems in using wireless systems in an environment, such as a home that may have many devices that transmit RF signals.

A first problem with conventional RF signaling is the bit rates of data transfers are too small. In home entertainment systems, devices such a television may require bit rate of up to 20 Mega Bits per second (Mbps). Convention RF signal cannot come close to providing this amount of throughput over the system.

A second problem with the use of wireless networks is interference from RF signals from other devices. If a device outside the system transmits at or near the same frequencies that device in a system communicate, the RF signals from the other device may be added to or subtracted from signals transmitted in the system. The addition or subtraction of the signals change the signals received by the device in the system and corrupting the data transmitted. The converse also may occur in that the signals from the system may interfere with RF signals to and from other devices not in the system. One example is a cordless telephone in the same room as a wireless home entertainment system.

A third problem is multi-path fading. Multi-path fading is the reception of copies of the same RF signals by device. Reception of copies occurs when signals are reflected from other objects in an environment such as walls. Thus, a receiver may receive a direct signal and several reflections that are out of phase that are copies of the direct signals. These copies may cause interference with the transmitted signal and corrupt the data.

A fourth problem is the RF signals used in the wireless system is priority of data transmitted. Some data is time sensitive and must have a priority for transmission. For example, in a home entertainment system, a DVD player must transmit video data to a television and audio information to a stereo in a continuous and reliable manner so that television and stereo may use the information to display and transmits a presentation to a user. Therefore, the DVD player must be able to continuously transmit the data in a manner that there will be no interruption of the data.

A fifth problem with wireless system is synchronizing the devices in a system. Devices must be synchronized to use the data in an intended manner. In the home entertainment system example, a television and stereo must be synchronized in order for the audio transmission of the stereo to match the video presentation of the television.

In order to minimize some of the above problems, those skilled in the art have turned to Ultra Wide Band (UWB) technologies. The use of UWB dates back to the 1940s. Orginally, UWB was used for radar system. Later, UWB was used for military communications.

UWB is a form of radio transmission. UWB employs short pulses of energy that spread across a wide range of frequencies. A UWB signal is a radio signal with a fractional bandwidth larger than 25%. For example, a UWB signal with a center frequency of 3 GHz has a minimum bandwidth of 750 MHz. Unlike conventional RF technologies, UWB modulates information into RF signals with a series of baseband, pulsed emissions transmitted without a carrier signal.

Therefore UWB has several inherent features that make UWB desirable for use for wireless communications for systems, such as home entertainment systems. First, UWB signals utilize a spectrum of frequencies already designated for other devices. Secondly, UWB signals also have a low power density which allows coexistence with other RF devices with minimal interference. Thirdly, UWB has a low probability of multi-path fading and interference.

Thus, there is a need in the art for providing a system for UWB communication that may be used in wireless systems to provide data between devices.

### SOLUTION

The above and other problems are solved and an advance in the art is made by the De-centralized UWB system of this invention. This invention provides a wireless system that has a high data transfer rate required for multi-media applications such as video. This invention also provides high stability under a wide range of loads. Loads mean the amount of RF transmissions in an environment. This invention also provides a wireless system that supports mixed traffic. Mixed traffic is priority, dedicated traffic such as video and audio data as well as burst traffic used for applications such as Internet access.

The above listed attributes of this system provide a system that may have an undetermined and changing number of devices connected to the system. A system designed in accordance with this invention may operate in an environment having overlapping systems. This is advantageous in a home entertainment system where signals in systems in other rooms of a home may not be blocked by objects such as wall in the home. Further since the system is wireless device may be moved with little or no though to wireless system.

In accordance with this invention, each device in the system includes a transceiver having an RF transmitter and RF receiver. The transmitter and receiver are each configured to operate with UWB signals. The transceiver is connected to a processing unit that executes applications to transmit and receive data packets via UWB.

The processing unit executes instructions from software stored in a memory of firmware to transmit data in accordance with this invention. In accordance with this invention, the processor in a device that requires a data transmission receives UWB signals being transmitted. When the device detects the system is idle of transmissions, the processor directs the transmitter to transmit arbitration pulses. The processor then waits to receive arbitration pulse signals from other devices requiring a data transmission. The processor then determines whether device has control of the system.

If the device has control of the system, the processor generates a control header including synchronization data. The synchronization data is used as described below by receiving devices to adjust a local clock for use in processing the received data. Encryption initialization data, link adaptation data, a source address of the transmitting device, a destination address of devices to receive the data, and a length of a data field of the packet may also be included in the control header. The control header is then placed in a data packet and sent to the transmitter. The transmitter then transmits the data packet using UWB.

The processor in the transmitting device then waits and determines whether an acknowledgement message is received from at least one of the receiving devices. The processor then reads data from the received acknowledgement message. Transmission parameters for transmitting messages may then be adjusted by the processor using data read from the acknowledgement message. When the transmission parameters are adjusted, the processor generates a new control header using the adjusted transmission parameters.

For each packet transmitted by a transmitting device, the processor also generates a payload portion of the packet and inserts the payload portion into the packet. The payload portions may include address information for receiving devices, a sequence number of the packet, transmission parameters, and user data. The processor then repeats the generation and transmission of packets until of the data that must be transmitted is sent.

The processors of the other devices in the system execute software or firmware to provide the following steps for receiving data from the transmitting device. First, the processor of a receiving device receives the data packet which is converted from UWB signals received by the receiver in the device. The processor of the receiving device then reads the control header from the data packet and determines whether the packet is addressed to the device.

The processor of the receiving device then adjusts a local clock from the synchronization data in the control header. If the packet is addressed to the receiving device, processor then reads data from the payload portion of the packet.

In the data from the payload portion, the processor may read transmission parameter data. The processor may then use the transmission parameter data to adjust systems such as the receiver in the receiving device.

The processor may then calculate optimizations for the system based upon the transmission parameter data and other received data.

In response to receiving the data packet, the processor may generate and transmit an acknowledgement message to the transmitting device. The calculate optimizations may be included into this acknowledgement message.

### BRIEF DESCRIPTION OF THE DRAWING FIGURES

The above and other features and objectives of this invention may be understood from the following detailed description and the following drawings:

FIG. 1 illustrating a block diagram of a decentralized wireless network;

FIG. 2 illustrating a block diagram of components in a device in the decentralized wireless network.;

FIG. 3 illustrating a flow diagram of a process executed by a transmitting device in accordance with this invention;

FIG. 4 illustrating a flow diagram of a process executed by a receiving device in accordance with this invention;

FIG. 5 illustrating a block diagram of a data packet transmitted in the wireless system in accordance with this invention;

FIG. 6 illustrating a block diagram of a control head of a data packet in accordance with this invention; and

FIG. 7 illustrating a block diagram of a payload portion of the data packet.

### DETAILED DESCRIPTION OF THE INVENTION

The following description of a wireless system in accordance with the invention is not intended to limit the scope of the invention to shown embodiments, but rather to enable any person skilled in the art of wireless systems to make and use the invention.

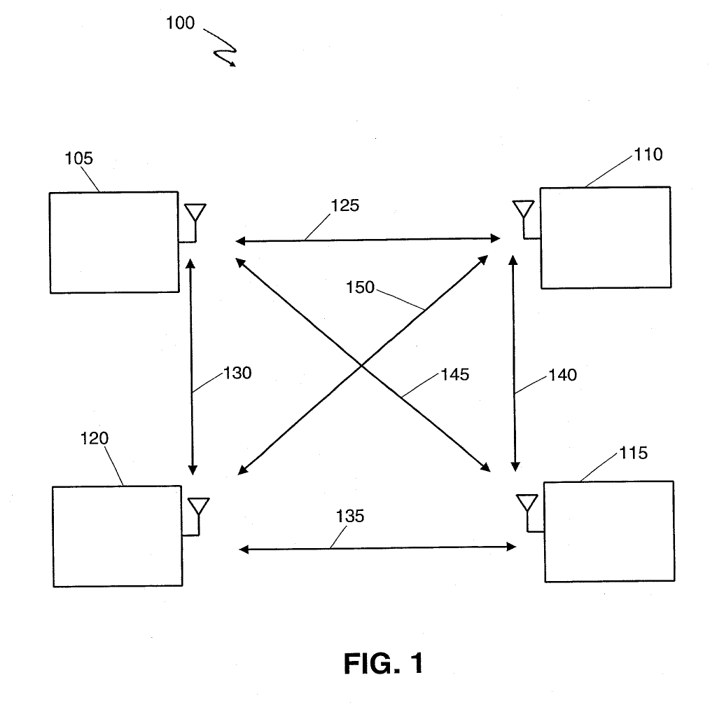

FIG. 1 illustrates a decentralized wireless network 100. Network 100 includes devices 105, 110, 120 and 125. One skilled in the art will recognize that the number of devices in the system is arbitrary and these devices are shown for exemplary purposes. Devices 105, 110, 120, and 125 communicate by transmitting Ultra Wide Band Signals 130, 135, 140, 145, and 150. Network 100 is decentralized meaning there is no master device controlling transmissions between devices. The transmission of UWB signals between devices is based upon the ETSI HIPERLAN/I standard. Those skilled in the art will recognize that other standards of communication may be used.

This decentralized network 100 provides peer to peer communications as well as extended communications via multi-hop delivery. An example of peer to peer communications is a transmission of data from device 105 to device 110 using UWB signals 125. An example of multi-hop communications is transmission of data from device 105 to device 115 by transmitting the data from device 105 to device 110. Device 110 then transmits the data to device 115.

Decentralized network 100 also allows uncontrolled deployment of devices, automatic topology management of devices, overlapping network, fair access to burst and priority traffic, and QoS support. Unlike a centralized network, decentralized network 100 does not require a master device to act as a scheduler for traffic.

Furthermore, decentralized network 100 provides the following features to be used in systems such as a home entertainment system. Decentralized network 100 allows for more flexible priority signaling. Decentralized network 100 also provides link adaptation and power control. Decentralized network 100 also provides a time synchronization method for devices and reduces processing delay.

In order to implement priority signaling, decentralized network 100 uses an active on-off signal of variable length preceding a transmission of a packet. In order to be compatible with Medium Access Communication (MAC) bridging implementations with priorities, eight levels of priority. The MAC bridging implementations are described in IEEE 802.1Q.

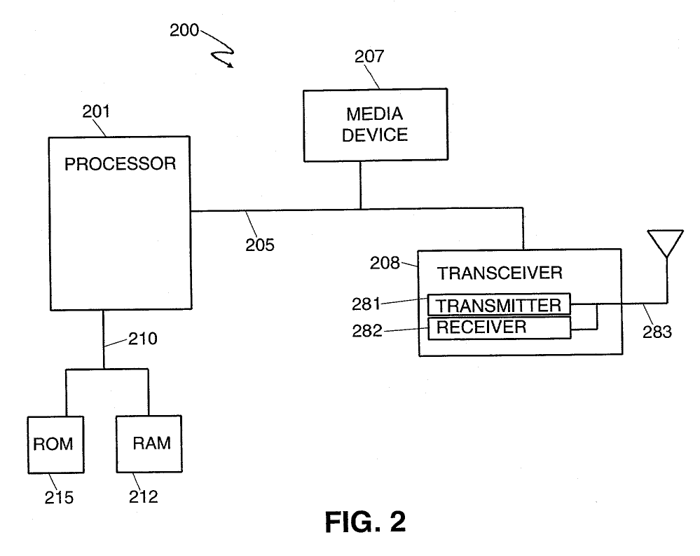

FIG. 2 illustrates a block diagram of a device 200 that operates as a device in decentralized system 100. Device 200 includes a processing unit 201. Processing unit 201 is a processor, microprocessor, controller or any combination thereof that executes instructions stored on a media to provide an application. Processor 201 is connected to a volatile memory such as Random Access Memory (RAM) 212 via memory bus 212. RAM 212 stores data and instructions which processing unit 201 uses to perform an application. Processor 201 is also connected to a non-volatile memory such Read Only Memory (ROM) 215 via memory bus 210. ROM 215 stores instructions for configuration and drivers needed by processing unit 201 to perform basic applications needed for set-up and control.

Input/Output (I/O) Bus 205 connects processing unit 201 to media device 207 and transmitter 208. Media device 208 is a device that uses the data received via communications over a wireless network to provide a function. In a home entertainment system, media device 207 may be a television, a DVD player, speakers, a stereo or other such device. One skilled in the art will recognize that processing unit 201 may execute other application for providing other functions in media device 207 or may be a unit separate from the other functions of media device 207.

Transceiver 208 receives and transmits data to processing unit 201 via I/O bus 205. Transceiver 208 includes a transmitter 281 which receives data from processing unit 201 and converts the data to UWB signals that are then applied to antenna 283 for transmission. In transmitter 208, circuitry may shape the time domain signal so that the associated spectrum optimizes the antenna transfer function for minimum transmission loss.

Receiver 282 receives UWB signals that are detected by antenna 283 and converts the UWB signals to data. The data is then transmitted to processing unit 201 over I/O bus 205. Receiver 282 is standard receiver for UWB signals and the particular design is omitted for brevity. One skilled in the art will recognize that that particular design of transceiver 208 and circuitry inside is left as design choice and transceiver 208 need only be configured to provide UWB transmission in accordance with this invention.

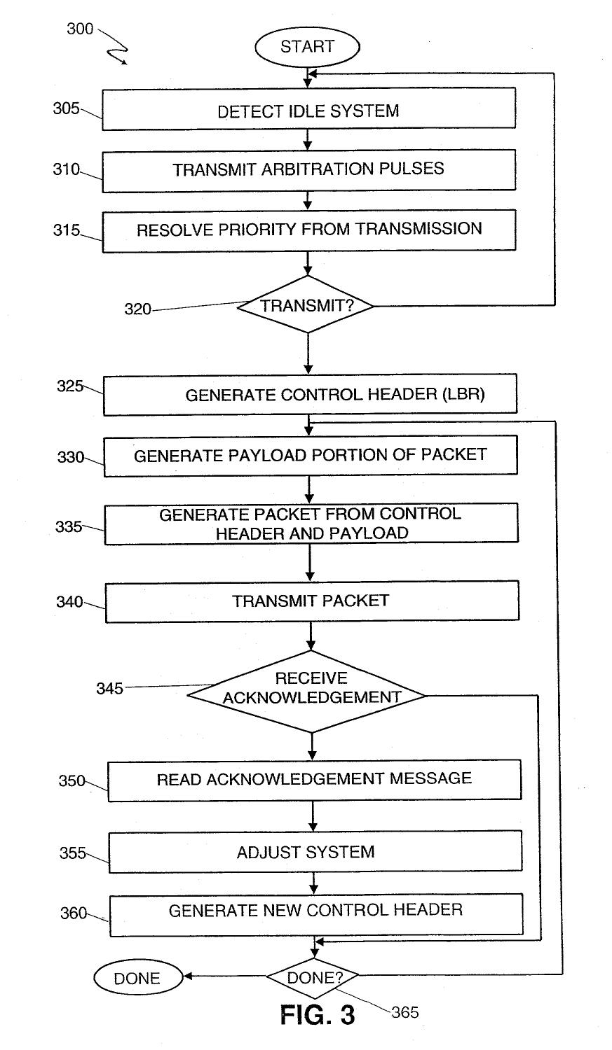

In order to provide wireless transmission in decentralized wireless network 100, devices in the network that require transmission execute software to perform the steps of process 300 illustrated in FIG. 3. Priority signaling is used to transmit priority data such as video and audio. When a device requires a data transmission to other devices, the transmitting device starts process 300 by detecting the system is idle in step 305. Detection is completed by determining no UWB signals have been detected for a specified amount of time.

After the transmitting device determines that system is idle, the processor sends signals to the transmitter to transmit arbitration pulses in step 310. In a preferred embodiment, the arbitration pulses are a sequence of twenty-four pulses. In step 315, priority of the device is resolved in step 320. In the preferred embodiment, zero to twenty-four pulses are used for resolution of the contention for transmitting. In step 325, the transmitting device determines whether the transmitting device has priority. If the transmitting device does not have priority steps 305 to 315 are repeated until the transmitting device gains priority.

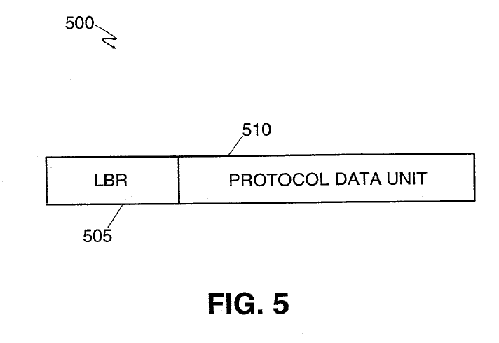

When the transmitting device has priority to transmit in step 325, the processor generates a packet for transmission. FIG. 5 illustrates a preferred embodiment of a packet to be transmitted. Packet 500 includes a control header 505 and a payload.

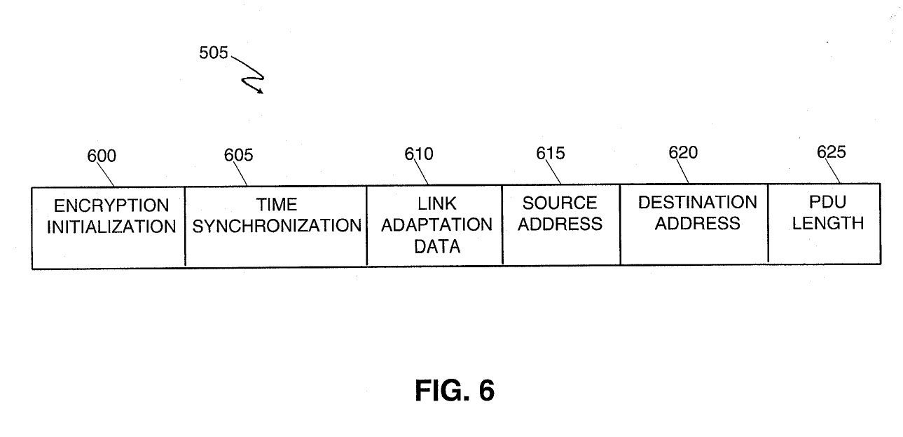

Referring back to FIG. 3, the processor generates the control header in step 325. In a preferred embodiment, control header 505 is a Low Bit-Rate (LBR) header. The LDR header is effectively an in-band signaling channel used to carry information about the payload and information for implementing data exchange for Link adaptation and power control algorithms. FIG. 6 illustrates a preferred embodiment of the control header as an LDR header 505. LDR header 505 includes the following fields. Encryption initialization field 600 which includes information a receiving device needs to decrypt data in the payload 505. In a preferred embodiment an RC4 cipher is used and encryption field 600 includes an initialization vector and a 2 bit key. One skilled in the art will understand that the type of encryption used will dictate the data in field 600 and the bit length of field 600.

Time synchronization field 605 carries synchronization data. This is data sent by the transmitting device to other devices for use in converging the local clock in each device with the data in order to synchronize the devices.

Link adaptation field 610 stores information defining pulse repetition frequency, modulation code and transmitted power level of the payload. This information is used to changes parameters of the receiver to better detect transmitted signal.

Source address field 615 includes the address of the transmitting devices and destination address field includes the address of the intended destination of the packet. Length field 625 stores a length of the transmitted packet for use in the receiving device. One skilled in the art will recognize that the length of these fields depends upon the addressing scheme used in network 100.

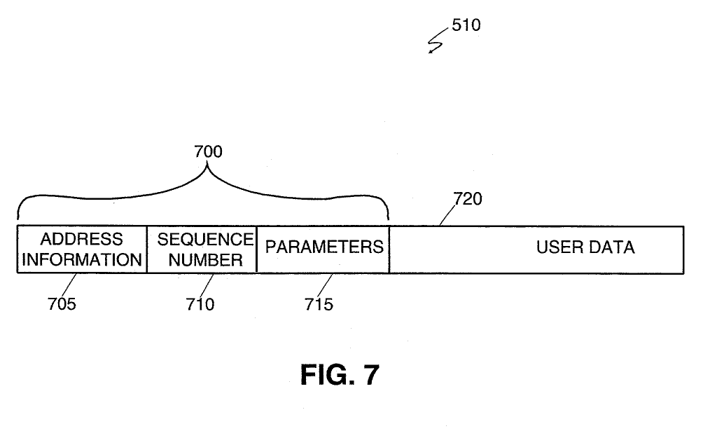

Referring back to FIG. 3, the processor in the transmitting device generates the payload for the packet in step 330. In a preferred embodiment, the payload is Protocol Data Unit (PDU). FIG. 7 illustrates a block diagram of a payload 510 of packet 500 (FIG. 5). In PDU 510, there is a PDU header 700 that includes PDU addressing field 705, sequence number field 710 and parameters field 715. PDU addressing field 705 includes addressing information. Sequence number 710 stores the sequence number of the packet in the packets being transmitted. Parameters field 715 stores original QoS parameters and residual lifetime parameters for use by the receiving device. Data field 720 stores the data being transmitted.

After the payload is generated, the processor in the transmitting device generates the payload in step 335 from the control header and generated payload. The processor then transmits the packet to the transceiver. The transmitter in the transceiver then transmits the packet in UWB signals.

If an acknowledgement message is required, the processor waits for the acknowledgement message in step 345. If no acknowledgment message is required, the processor continues to steps 365. If an acknowledgment message is required, the processor waits for the acknowledge message to be received in step 345.

The processor then reads the received acknowledgment message in step 350. The acknowledgement message may include information that is needed by the transmitting device to modify transmission parameters. Transmission parameters may include pulse repetition frequency, a modulation code, and transmitted power level. The processor of transmitting device adjusts the transmission parameters based upon the information in the acknowledgement message in step 355. In step 360, a control header is generated in response to the new transmission parameters generated in step 355.

In step 365, the processor determines whether more data must be transmitted. If more data must be transmitted, process 300 is repeated from step 330 until of the data has been transmitted. Other process 300 ends.

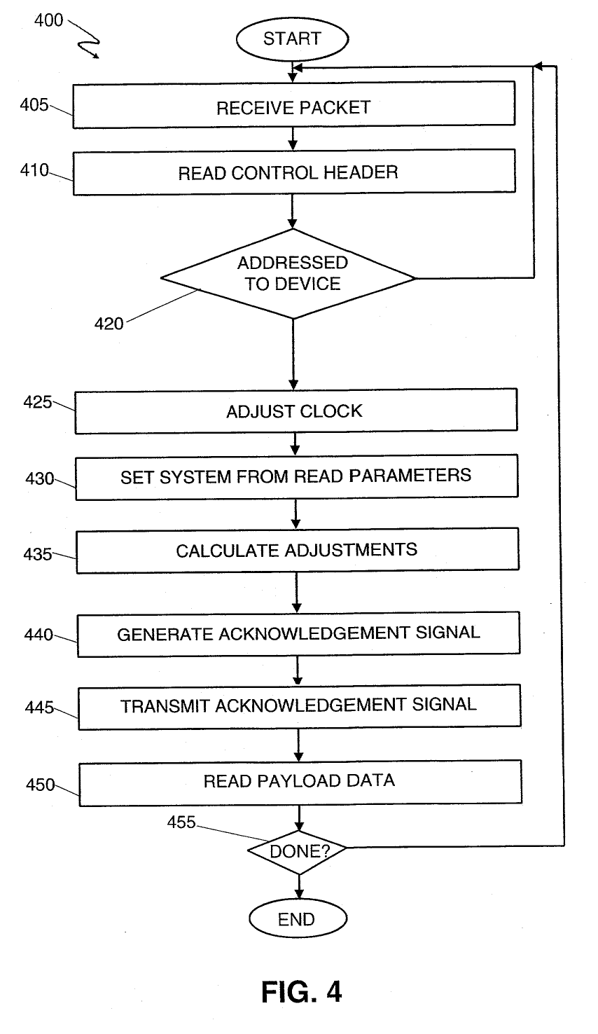

A process 400 by which a device in decentralized network 100 receives and processes packets is illustrated in FIG. 4. Process 400 begins when a processor in a receiving device receives a packet that was converted to data by a receiver in the device from UWB signals received by the device in step 405. In step 410, the control header of the received packet is read. From the control header, the processor in receiving device determines whether the packet is addressed to the receiving device in step 420. If the packet is not addressed to the receiving device, process 400 may end or wait until another packet is received.

If the packet is addressed the receiving device, the processor performs convergence with synchronization data on a local clock in step 425. In other embodiments even devices for which the packet is not addressed may use the synchronization data to adjust a local clock through convergence.

In step 430, the receiving device may set system parameters based upon data read from the control header, this may include decryption algorithms, link adaptation parameters, and other parameters the device needs for transmission. After the systems parameters are set, the receiving device may use the received data, the receive level of the receiving device and detected error rate to calculate suggested changes to the transmission parameters in step 435.

In step 440, an acknowledgement message is generated if required. The acknowledgement message is a packet including information that is sent to the transmitting device to improve transmission between the devices. The acknowledgement message may include the calculated suggested changes from step 435. In step 445, the processor of the receiver device transmits the acknowledgement message to the transmitter of the receiver device which in turn transmits the acknowledgement packet in UWB signals.

In step 450, the data in the payload is then read and processed for further use by the device. In step 455, the receiver device then determines whether the transmitted device is finished transmitting signals. If so, process 400 ends. Otherwise process 400 is repeated from step 405.

As any person skilled in the art of wireless communications will recognize from the previous description and from the figures and claims, modifications and changes can be made to the preferred embodiments of the invention without departing from the scope of the invention defined in the following claims.

What is claimed is:

1. A communication system transmitting data between a plurality of device using Ultra Wide Band (UWB) radio frequencies, said system comprising:
each of said plurality of devices include:
a processing unit,
a media connected to said processor that is readable by said processing unit and stores instructions for directing said processing unit to perform instructions,
a transmitter connected to said processing unit that transmits data received from said processing unit over said Ultra Wide Band Radio frequencies, and
a receiver connected to said processing that receives signals said Ultra Wide Band radio frequencies and converts said signals to data readable by said processing unit; and
wherein a one of said plurality of devices that requires a data transmission over said system to other ones of said plurality of devices include:
instructions stored in said media for directing said processing unit to:
determine said system is idle of transmitted signals,
transmit arbitration pulses to said transmitter of said device,
receive signal from other ones of said plurality of devices requiring a data transmission,
determine whether said one of said plurality of devices has control of said system,
generate a control header including synchronizing data,
insert said control header into a data packet, and
transmit said data packet to said transmitter in said one of said plurality of device that transmits said packet over said system in said Ultra Wide Band frequencies.

2. The system of said claim 1 wherein instructions for directing said processing unit in said one of said plurality of device requiring a data transmission comprises:
instructions for directing said processing unit in said one of said plurality of device to:
insert encryption initialization data into said control header.

3. The system of said claim 1 wherein instructions for directing said processing unit in said one of said plurality of device requiring a data transmission comprises:
instructions for directing said processing unit in said one of said plurality of device to:
insert link adaptation data in said control header.

4. The system of said claim 1 wherein instructions for directing said processing unit in said one of said plurality of device requiring a data transmission comprises:
instructions for directing said processing unit in said one of said plurality of device to:
insert a source address of said one of said plurality of devices transmitting said data.

5. The system of said claim 1 wherein instructions for directing said processing unit in said one of said plurality of device requiring a data transmission comprises:
instructions for directing said processing unit in said one of said plurality of devices to:
insert a destination address of a one of said plurality of devices to receive said data.

6. The system of said claim 1 wherein instructions for directing said processing unit in said one of said plurality of device requiring a data transmission comprises:
instructions for directing said processing unit in said one of said plurality of devices to:
insert a length of data field of said packet into said control header.

7. The system of claim 1 wherein said instructions for directing said processing unit in said one of said plurality of devices further comprises:
instructions for directing said processing unit in said one of said plurality of devices to:
determine whether an acknowledgement message is received from a one of said plurality of devices to receive to said data transmission.

8. The system of claim 7 wherein said instructions for directing said processing unit in said one of said plurality of devices further comprises:
instructions for directing said processing unit in said one of said plurality of devices to:
read data from said acknowledgement message responsive to a determination said acknowledgement message is received.

9. The system of claim 8 wherein said instructions for directing said processing unit in said one of said plurality of devices further comprises:
instructions for directing said processing unit in said one of said plurality of devices to:
adjust transmission parameters for transmitting messages using said data read from said acknowledgement message responsive to receiving said message.

10. The system of claim 1 wherein said instructions for directing said processing unit in said one of said plurality of devices further comprises:
instructions for directing said processing unit in said one of said plurality of devices to:
generate a new control header using said system parameters responsive to adjusting said transmission parameters.

11. The system of claim 1 wherein said instructions for directing said processing unit in said one of said plurality of devices further comprises:
instructions for directing said processing unit in said one of said plurality of devices to:
generate a payload portion of said packets, and
insert said payload portion in said packet.

12. The system of claim 11 wherein said instructions for directing said processing unit in said one of said plurality of devices to generate said payload portion further comprises:
instructions for directing said processing unit in said one of said plurality of devices to:
insert address information into said payload portion.

13. The system of claim 11 wherein said instructions for directing said processing unit in said one of said plurality of devices to generate said payload portion further comprises:
instructions for directing said processing unit in said one of said plurality of devices to:
insert a sequence number of said packet into said payload portion.

14. The system of claim 11 wherein said instructions for directing said processing unit in said one of said plurality of devices to generate said payload portion further comprises:
instructions for directing said processing unit in said one of said plurality of devices to:
insert transmission parameters into said payload portion.

15. The system of claim 11 wherein said instructions for directing said processing unit in said one of said plurality of devices to generate said payload portion further comprises:
instructions for directing said processing unit in said one of said plurality of devices to:
insert user data into said payload portion.

16. The system of claim 11 wherein said instructions for directing said processing unit in said one of said plurality of devices further comprises:
instructions for directing said processing unit in said one of said plurality of devices to:
determine whether there is more data to transmit, and
repeat said instructions to generate said payload portion, generate a packet and transmit said packet responsive to a determination there is more data to transmit.

17. The system of claim 1 wherein each of said plurality of device further comprises:
instructions stored on said media for directing said processing unit in said device to:
receive said data packet converted from signals in said Ultra Wide Band Frequencies received by said receiver,
read said control header from said data packet, and
determine whether said packet is intended for said device responsive from data in said control header.

18. The system of claim 17 wherein said instructions in each of said plurality of devices further comprise:
instructions stored on said media for directing said processing unit to:
adjust a local clock from said synchronization data in said control header.

19. The system of claim 17 wherein said instructions in each of said plurality of devices further comprise:
instructions stored on said media for directing said processing unit to:
read data from said packet in response to a determination said packet is addressed to a one of said plurality of device that includes said processing unit.

20. The system of claim 17 wherein said instructions in each of said plurality of devices further comprise:
instructions stored on said media for directing said processing unit to:
read transmission parameter data from said packet in response to a determination said packet is addressed to a one of said plurality of device that includes said processing unit.

21. The system of claim 20 wherein said instructions in each of said plurality of devices further comprise:
instructions stored on said media for directing said processing unit to:
adjust systems in said device based upon said transmission parameter data.

22. The system of claim 17 wherein said instructions in each of said plurality of devices further comprise:
instructions stored on said media for directing said processing unit to:
generate an acknowledgement message in response to receiving said packet.

23. The system of claim 22 wherein said instructions in each of said plurality of devices further comprise:
instructions stored on said media for directing said processing unit to:
calculate adjustments to transmission parameters, and
add said calculated adjustments to said acknowledgement message.

24. A method for transmitting data between a plurality of devices using Ultra Wide Band frequencies comprising:
detecting in a transmitting device absence of transmitted signals;
transmitting arbitration pulses from said transmitting device;
receiving arbitration pulses from other ones of said plurality of devices requiring a data transmission in said transmitting device;
determining whether said transmitting devices has control;
generating a control header including synchronizing data in said transmitting device;
inserting said control header into a data packet; and
transmitting said data packet from said transmitting device in said Ultra Wide Band frequencies.

25. The method of claim 24 further comprising:
inserting encryption initialization data into said control header.

26. The method of claim 24 further comprising:
inserting link adaptation data in said control header.

27. The method of claim 24 further comprising:
inserting a source address of said one of said plurality of devices transmitting said data.

28. The method of claim 24 further comprising:
inserting a destination address of a one of said plurality of devices to receive said data.

29. The method of claim 24 further comprising
inserting a length of data field of said packet into said control header.

30. The method of claim 24 further comprises:
receiving an acknowledgement message in said transmitting device from a one of said plurality of devices that receives said data transmission.

31. The method of claim 30 further comprises:
reading data from said acknowledgement message responsive to a receiving said acknowledgement message is received.

32. The method of claim 32 further comprises:
adjusting transmission parameters for transmitting messages in said transmitting device using said data read from said acknowledgement message responsive to receiving said message.

33. The method of claim 24 further comprises:
generating a new control header in said transmitting device using said system parameters responsive to adjusting said transmission parameters.

34. The method of claim 24 further comprises:
generating a payload portion of said packets in said transmitting device; and
inserting said payload portion in said packet.

35. The method of claim 34 wherein said step of generating said payload portion of said packet in said transmitting device comprises:
inserting address information into said payload portion.

36. The method of claim 34 wherein said step of generating said payload portion comprises:
inserting a sequence number of said packet into said payload portion.

37. The method of claim 34 wherein said step for generating said payload portion comprises:
inserting transmission parameters into said payload portion.

38. The method of claim 34 wherein said step for generating said payload portion comprises:
inserting user data into said payload portion.

39. The method of claim 34 further comprises:
determining whether said transmitting device has more data to transmit; and
repeating said steps for generating said payload portion, generating a packet and transmitting said packet responsive to a determination there is more data to transmit.

40. The method of claim 24 further comprising:
receiving said data packet in said Ultra Wide Band Frequencies by a receiver device;
reading said control header from said data packet in said receiver device; and
determining whether said packet is intended for said receiver device responsive to reading data in said control header.

41. The method of claim 40 further comprising:
adjusting a local clock in said receiver device from said synchronization data in said control header.

42. The method of claim 40 further comprising:
reading data from said data packet in said receiver device in response to a determination said packet is addressed to said receiver device.

43. The method of claim 40 further comprising:
reading transmission parameter data from said packet in said receiver device in response to a determination said packet is addressed to said receiver device.

44. The method of claim 43 further comprising:
adjusting systems in said receiver device based upon said transmission parameter data in response to reading said transmission parameter data.

45. The method of claim 40 further comprising:
transmitting an acknowledgement message from said receiver device in response to receiving said packet.

46. The method of claim 45 further comprising:
calculating adjustments to transmission parameters in said receiver device; and
inserting said calculated adjustments into said acknowledgement message.
